(19) United States
(12) Patent Application Publication
(10) Pub. No.: US 2013/0249252 A1
(43) Pub. Date: Sep. 26, 2013

(54) MOLDING FOR A VEHICLE-SIDE CARRIER STRUCTURE FOR FASTENING A ROOF LOAD CARRIER DEVICE, AND ROOF CARRIER DEVICE FOR FASTENING A ROOF LOAD CARRIER DEVICE WITH THE MOLDING

(71) Applicant: AUDI AG, Ingolstadt (DE)

(72) Inventors: Wolfgang Schmid, Freising (DE); Ulrich Pfeiffer, Karlskron / Probfeld (DE)

(73) Assignee: Audi AG, Ingolstadt (DE)

(21) Appl. No.: 13/848,899

(22) Filed: Mar. 22, 2013

(30) Foreign Application Priority Data
Mar. 23, 2012 (DE) 10 2012 005 888.8

(51) Int. Cl. B60R 9/00; B60W 40/12; B60W 30/04

(52) U.S. Cl. CPC B60R 9/00; B60W 30/04; B60W 40/12; B60W 2040/1315
USPC 296/210; 701/37

(57) ABSTRACT

A molding for a vehicle side carrier structure has hat least one recess for receiving a securing means of a roof load carrier device, the cross section of the molding is configured so that a roof load carrier device is only detachably fastenable to the molding by engagement of at least one securing means provided on the roof load carrier device in the at least one recess of the molding, and at least one sensor device is configured for detecting a change of a magnetic field in the region of the recess. The present invention further relates to a roof carrier arrangement with the molding according to the invention for fastening a roof load carrier device and a method for controlling a driver assist or driver stabilizing program of a vehicle.

### CROSS-REFERENCES TO RELATED APPLICATIONS

This application claims the priority of German Patent Application, Serial No. 10 2012 005 888.8, filed Mar. 23, 2012, pursuant to 35 U.S.C. 119(a)-(d), the disclosure of which is incorporated herein by reference.

### BACKGROUND OF THE INVENTION

The present invention relates to a molding for a carrier structure on a vehicle for fastening a roof load carrying device, a roof carrier arrangement for fastening a roof load carrier device and a method for controlling a driver assist system or driver stabilizing program of a vehicle.

The following discussion of related art is provided to assist the reader in understanding the advantages of the invention, and is not to be construed as an admission that this related art is prior art to this invention.

A shifting of the center of gravity of a vehicle in vertical direction has a significant influence on the driving dynamics. Such a shifting of the center of gravity of a vehicle occurs in particular when the vehicle is operated with roof loads. A roof load can thus cause a critical driving behavior.

In particular in off road vehicles, vans or SUVs (Sport Utility Vehicles), which already have a relatively high center of gravity, a further raising of the center of gravity can be critical with regard to the risk of falling over or toppling over.

A possible precaution against such a critical driving behavior is to configure the chassis control via the electronic stabilizing program ESP in such a manner that a rather early ESP-intervention occurs in order to still have a sufficient safety margin in potentially dangerous driving situations. In general however, this requires a relatively unsporting chassis adjustment with a relatively strong over-steering configuration or a limitation of the transverse acceleration.

However, customers expect a dynamic driving behavior of their vehicle even when it has a high center of gravity which, however, is not possible with the described early ESP-intervention.

With this in mind, methods and systems have been developed for recognizing a roof load. This allows inter alia regulating an ESP-intervention in dependence on the presence of a roof load.

Devices on vehicles for fastening a roof load carrier device often have a so called roof railing. A roof railing is usually formed by two structures which extend in longitudinal direction of the vehicle and are fastened in the region of the lateral borders of the vehicle roof so as to have a transverse clearance to each other. These structures can be configured as railing rods (holms) or railing moldings and be provided on the vehicle roof with or without support feet for support on the vehicle roof. The structures and/or support feet are often also adjusted to the shape of the vehicle roof.

Solutions are known in which the railing rods or railing profiles terminate flush with the vehicle roof over their entire length, i.e., in the installed state no intermediate space is present between the railing rods or railing profiles protruding from the vehicle roof and the outside of the vehicle roof. The railing rods or railing profiles often do not rest on the roof of the vehicle but are arranged at least partially in a roof channel or a similar structure of the roof. In order to be able to arrange roof load carrier devices securely on the railing rods or railing profiles, the roof railing is usually fastened on vehicle body elements provided for this purpose.

A roof load carrier device can be fastened on the structures of the roof railing by suitable securing means such as for example screwing or clamping devices. A roof load carrier device is often formed by two cross members which in turn can be fastened to transport devices (bicycle carrier, surfboard carrier, etc.) which are specifically adapted to particular loads.

For safety reasons, the fastening of a roof load carrier device to a carrier structure on a vehicle has to have a sufficient stability and strength. In Germany, the safety requirements for roof load carrier devices of automobile and related vehicles are defined in DIN 75302. According to this, roof load carrier devices must satisfy defined minimal requirements with regard to shift safeness, shaking resistance, quasi-static load capacity, and stress by side wind forces.

For example, for testing the shifting safeness, a vehicle is decelerated from a starting velocity of 80 km/h three times on a plane road by 72%, wherein the roof load carrier device is loaded with 1.5 times the specified carry capacity. Under these circumstances, no support foot must shift by more than 3 mm and the fastening torque of any screw connection must not decrease by more than 30%.

Further, roof load carrier devices also have to be able to for example withstand the expected lift forces during normal operation. For this according to DIN 75302 both carrier brackets are loaded with the load specified for the normal operation or with similar objects. The driving force FA according to table 5 of DIN 75302 is introduced at the front carrier bracket by the load (for example 2500 N in the case of universal carrier, 500 N per started 0.25 meters width in the case of roof container). The lift force FA according to table 5 is to be introduced so that the fastening elements to be tested are evenly exposed to load. The load time is 10 minutes. After the testing, neither the fastening element must detach from the carrier rod, nor must the load change visibly.

A roof railing according to the state of the art is therefore shaped over at least a predominant portion of its length so that conventional roof load carrier systems can be fastened thereto—with the already mentioned screw or clamping connections so that they satisfy the statutory safety requirements.

This configuration of the roof railing according to the state of the art has the disadvantage however, that systems with which the presence of a roof load carrier device is to be detected, are comparatively complicated and have to be configured with high technical effort. Such systems have to be configured for a multitude of roof load carrier devices which often have different fastening points and fastening systems, in order to reliably detect the presence or absence of a roof load carrier device.

It would therefore be desirable and advantageous to provide a technical solution which is improved compared to the known state of the art, and by which every type of roof load carrier device can be recognized in a simple and reliable manner.

### SUMMARY OF THE INVENTION

According to one aspect of the present invention, a molding for a carrier structure on a vehicle, has at least one recess for receiving a securing means of a roof load carrier device, and includes at least one sensor device arranged in the molding, wherein the at least one sensor is configured for detecting a change of a magnetic field in a region of the recess and/or an engagement of the securing means in the recess, wherein the molding is shaped in longitudinal direction for fastening on a motor vehicle without a clearance between a bottom side or a lower free end of the molding and an outer surface of a roof, and has a cross sectional shape so as to enable a fastening of the roof load carrier device to the molding only by engagement of the at least one securing means in the at least one recess of the molding.

The molding according to the invention has an outer shape which cannot be clamped by any of the conventional commercially available roof carrier devices, i.e., conventional commercially available roof carrier devices can not form a self locking clamping in friction connection with the molding according to the invention, which satisfy the above mentioned requirements on the holding force (DIN 75302: 1991-02; or future versions of this DIN-standard).

According to another advantageous feature of the present invention, when the molding is fastened on the motor vehicle, the angles at the imaginary intersection between the sides of the molding and the roof surface are greater than 90° and smaller than 150°, and the cross sectional width of the molding continuously decreases with increasing distance to the roof surface. Further suitable angular ranges at the imaginary intersection between the sides of the molding and the roof surface are for example at least 100° and smaller than 150°, at least 110° and smaller than 150°, at least 120 and smaller than 150°, at least 130° and smaller than 150°, at least 135° and smaller than 150° and at least 140° and smaller than 150°.

According to another advantageous feature of the present invention, the part of the molding which after fastening to the vehicle protrudes from the roof of the vehicle has, with the exception of the recesses, essentially the shape of a circular section in transverse direction essentially along its entire length with a center angle of smaller than 180° , the shape of an elliptical segment, wherein the length of the elliptical segment is smaller than 50% of the circumference of the ellipsis, a two-sided shape, or a three-sided shape with inner angles greater than 90°, wherein the corners of the a two-sided shape and a three-sided shape can be rounded.

Examples for such configurations are shown in the Figures and are explained in more detail in the description of the Figures.

There are no particular requirements with regard to the shape and number of the recesses in the molding according to the invention. When the roof load carrier device is configured as a one-piece unit (for example in the shape of a luggage carrier base which in operational condition is only one-piece) only one recess may be sufficient. For sufficient stabilization in rotational direction about the recess, parts of the roof load carrier device may for example be supported on the molding according to the invention. Because many commercially available roof load carrier devices have spaced apart cross members it can be advantageous when the molding according to the invention has at least two recesses which are spaced apart by an appropriate distance. This facilitates adjustment of conventional roof load carrier devices to the molding according to the invention.

Depending on the type of roof load carrier device to be used more then two recesses can of course also be provided. The arrangement of the at least one recess in the molding and the distance of multiple recesses a person with skill in the art is able to select.

In ready-to-use condition, i.e., after mounting of the molding on the vehicle, the recess(es) can generally extend in any direction, so long as their opening is located in the region of the molding, which region in the mounted condition protrudes over the outer surface of the roof. This/these recess(es) can for example essentially extend in horizontal direction and essentially transverse to the longitudinal axis of the vehicle, or deviate from the horizontal direction and/or the transverse direction by up to plus/minus 5°, plus/minus 10°, plus/minus 15°, plus/minus 20°, plus/minus 25°, plus/minus 30°, plus/minus 35°, plus/minus 40° or plus/minus 45°.

It is also possible that the recesses in the ready-to-use condition extend essentially vertically or deviate from the vertical extension by angular ranges as stated above with regard to the deviation from the horizontal orientation. When the recess(es) extend essentially vertical, a secure fastening of a roof load carrier device is possible for example when the recess(es) has/have an internal thread or have a shape appropriate for a ball lock pin, and the securing means of the roof load carrier device has a threaded bolt or a ball lock pin adjusted thereto.

Of course, it can also be provided that different recesses inside the molding extend within the above stated range in different directions.

The at least one recess can have any appropriate shape, for example an essentially round, angled or vertically longitudinal shape, a shape with an inner thread, a shape appropriate for a ball lock pin, and so on. The diameter of the recess merely has to be dimensioned appropriately. The securing means of the roof load carrier device engages in the recess(es) and thus significant forces may act on the securing means when using the roof load carrier device on a vehicle. A defined minimal diameter of the recess which depends on the material and the shape of the securing element is therefore selected by the person with skill in the art in an appropriate manner.

The molding according to the invention has at least one sensor device which is configured for detecting a magnetic field change in the region of the recess and/or the engagement of a securing means in a recess. For this, any appropriate sensor device can be used for example a sensor device which has a mechanically or contactless operating sensor device.

According to another advantageous feature of the present invention, the sensor device can have a mechanical switching device, a magnetic sensor device and/or a sensor device on the basis of an optical light barrier. A mechanical switching device can for example be formed in the shape of a button, which is switched by the engagement of the securing means in the recess of the molding according to the invention. The “open” or “closed” state of the switch is analyzed by corresponding control devices of the vehicle and taken into account for example for the regulation of the ESP-system.

Examples for a magnetic sensor device are a Reed-contact and a Hall sensor. Magnetic sensor devices can detect the presence and/or change of a magnetic field. For example, the securing means of the roof load carrier device can have itself magnetic properties or a magnetic field can be changed by engagement of the securing means in the recess of the molding. The present invention also includes embodiments in which the recess(es) of the molding can be provided with (a) cover(s) (for example covers or blind screws, which can be folded away sideways). These covers(s) can contain magnets or have itself/themselves magnetic properties. When for example a cover which can be folded away sideways is folded sideways by a securing means of the roof load carrier device which engages in the recess, or when a blind screw is removed in order to enable engagement of the securing means of the roof load carrier device in the recess, the magnetic field changes in both cases in the region of the recess. This change of the magnetic field can be detected by a magnetic sensor device. In the same manner, the magnetic field which is generated by a not folded away cover or by a screwed in blind screw, can be detected by a magnetic sensor device.

A sensor device on the basis of an optical light barrier can detect the engagement of a securing means in the recess of the molding either directly (for example in that a light beam is interrupted by engagement of the securing means) or indirectly (for example by causing movement of a pin-like means in the recess as a result of the engagement of the securing means).

The molding can be an essentially hollow section or solid section. When the molding is an essentially solid section, it has for example only recesses formed in the material for the sensor device(s).

There are also no particular requirements with regard to the material of the molding, and any appropriate material or an appropriate combination of materials can be used. Thus, the molding can be essentially made of a metal, a metal alloy, a plastic material or a combination thereof. Appropriate metals/metal alloys are for example aluminum/aluminum alloys, iron and steel. An example for an appropriate plastic material is carbon fiber reinforced plastic.

According to another aspect of the present invention a roof carrier arrangement for fastening a roof load carrier device on the roof of a vehicle includes two moldings which are mounted transversely spaced apart and essentially in parallel to one another on the roof of a vehicle, wherein at least one of the molding is a molding according to the invention. For reasons of esthetics, the roof carrier arrangement usually has two moldings with the same external design, i.e. the second molding will have the same design as the first molding. Further, the second molding also advantageously can have at least one recess for engagement of the securing means of the roof load carrier device. Therefore, the second molding of the roof carrier arrangement, with the exception of the sensor device, can have the same features as the first molding. Of course, in order to achieve an even higher safety with regard to the detection of a roof load carrier device, the second molding can have all the features of the first molding, i.e., also a sensor device.

According to another aspect of the present invention, a method for controlling a driver assist system or driver stabilizing system of a vehicle includes the steps of providing a vehicle with a roof carrier arrangement according to the invention, detecting the signal of the sensor unit which is present in at least one of the moldings of the roof carrier arrangement and transmitting of the signal to a control device of the driver assist system or driver stabilizing system, and controlling the driver assist system or driver stabilizing system by the control device as a function of the magnetic field in the region of the recess(es) of the molding and/or as a function of a detected presence or absence of a roof carrier device.

When the driver assist system or driver stabilizing system is controlled by the control device as a function of a detected change of the magnetic field in the region of the recess(es) of the molding, it can be stored in the control device that in case of absence of a roof load carrier device either a defined magnetic field (for example in case of the above mentioned cover(s) or blind screws which can be folded away) is present or not. When a magnetic state in the region of the at least one recess is detected by the sensor device which magnetic state deviates from this, the presence of a roof load carrier device on the vehicle can be assumed and the driver assist system or driver stabilizing system can be controlled accordingly.

The method can for example be carried out so that the signal of the at least one sensor device is analyzed continuously or in predeterminable time intervals. The method can advantageously also be performed in dependence on defined driving or vehicle conditions, for example in that the signal of the sensor device is detected when igniting the ignition, when starting the driving device (for example an internal combustion engine or electric engine) of the vehicle and/or after standstill of the wheels. When detecting the signal after a standstill of the wheels, it can further be provided that the detection only occurs when the standstill of the wheels has lasted for a defined minimal time period.

When the magnetic field is changed by the method in the region of the recess(es) of the molding and/or the presence of a roof load carrier device is determined, this condition is advantageously related to the driver assist programs or driving stabilizing programs via the vehicle bus system, in order to enable the driver assist programs and driving stabilization programs to carry out their interventions for achieving a maximal driving safety at maximally possible driving dynamic.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a cross section through a molding according to the invention, having essentially the shape of a circular section in transverse direction;

FIG. 2 shows a cross section through a further molding according to the invention having an essentially three-sided cross sectional shape with rounded corners and bossed sides;

FIG. 3 shows a cross section through a further molding according to the invention having an essentially three-sided cross sectional shape with rounded corners;

FIG. 4 shows a cross section through a further molding according to the invention, wherein the cross section has essentially the shape of an elliptical segment;

FIG. 5 shows a cross section through a further molding with a two-sided shape cross sectional shape.

FIG. 6 shows a cross section through a molding according to the invention, mounted on a roof of a vehicle and a part of a roof load carrier device fastened thereto.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

In the Figures, only the part of the molding is shown which in the installed condition protrudes over the outer surface of the roof 2, 3. The bottom side of the molding 1 according to the invention can be configured in any desired manner for fastening to the vehicle body of the vehicle, for example with a closed side or with at least one open end. Appropriate means for fastening to the body of the vehicle can also be present. The fastening of the molding 1 to the body of the vehicle can be implemented by any appropriate connection technique.

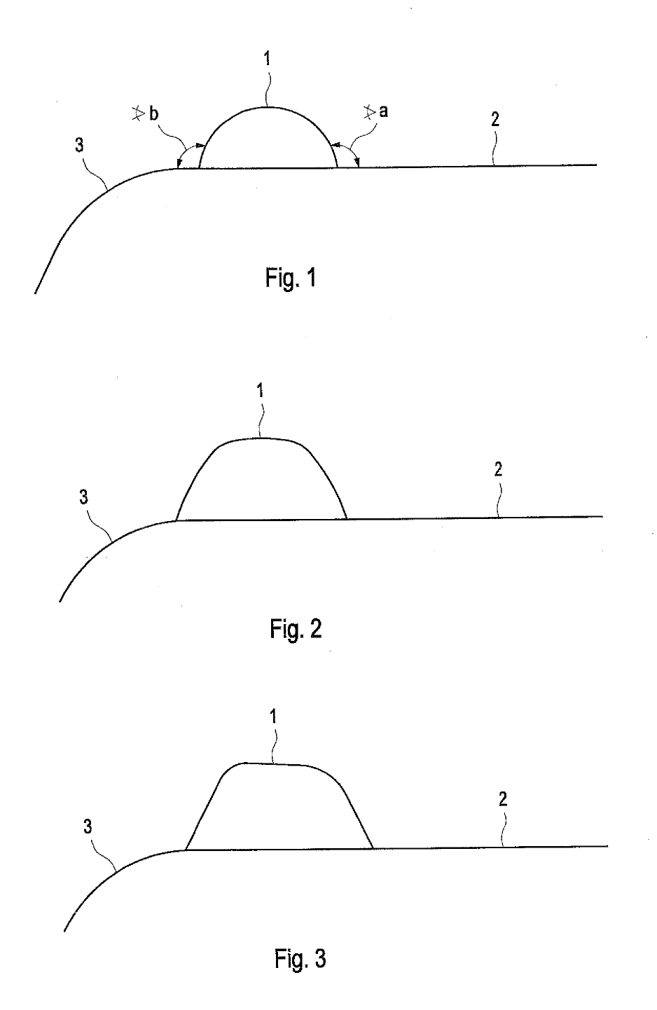

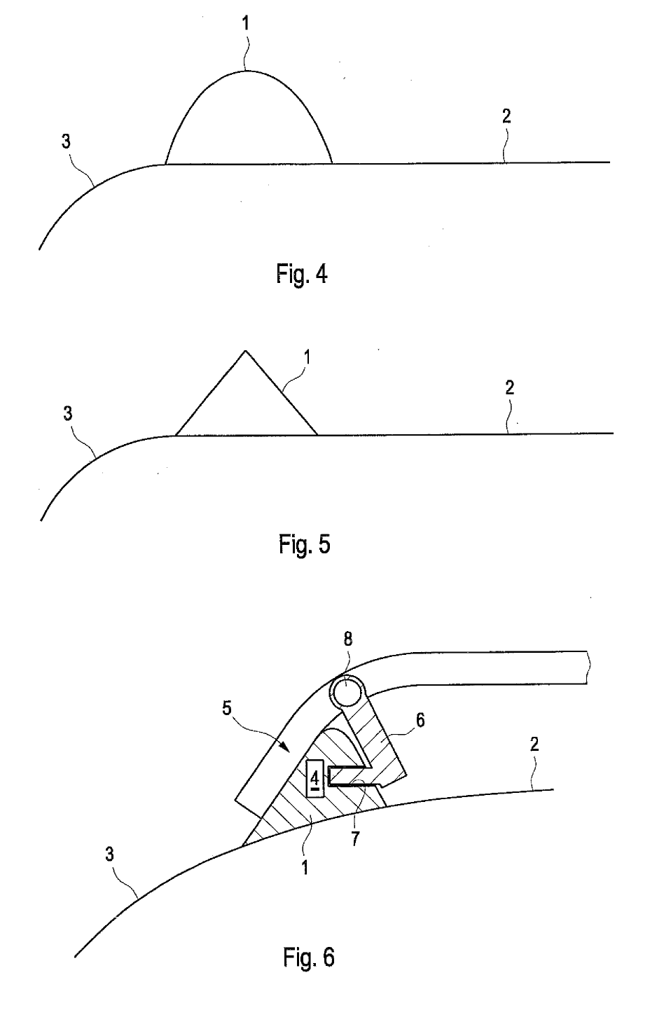

FIGS. 1 to 5 show examples for the possible cross sections of the molding according to the invention, as they protrude in the mounted state from the roof 2, 3 of a vehicle. In the shown examples, the molding 1 is mounted near the roof edge 3. Of course, any suitable distance of the molding 1 to the roof edge 3 can be selected.

For reasons of simplicity, the sensor device 4 and the recess 7 are not shown in FIGS. 1 to 5. FIGS. 1 to 5 merely serve for illustrating examples for possible shapes of the molding according to the invention in a cross section.

As can be seen from FIGS. 1 to 5, the cross section of the molding 1 has no side which is inclined or shaped so that a conventional roof load carrier device (roof load carrier) can be fastened thereto with conventional screw or clamping devices in such a manner that the statutory minimal requirements are satisfied. This is achieved in the shown examples in that the angles a and b (as shown exemplary in FIG. 1) are greater than 90° at the imaginary intersection between molding 1 and roof surface 2, 3, and in that the cross sectional width of the molding 1 continuously decreases with increasing distance to the roof line 2, 3.

FIG. 6 shows a molding according to the invention in cross section on a roof 2 of a vehicle and mounted near the roof edge 3. Further, FIG. 6 schematically shows a sensor device 4.

A roof load carrier device 5 can be fastened to the molding 1 only by engagement of a securing means 6 provided in the roof load carrier device 5 in the recess 7 provided in the molding 1. Such a securing means 6 can for example be an arresting latch or can include an arresting latch. For enabling movement of the securing means from a first position into a second position in which the securing means 6 can be in engagement with the recess 7, a joint 8 can be provided on the roof load carrier device 5. Such a joint 8 can be configured so as to be fixable in the second position in order to ensure a secure fastening to the roof load carrier device 5 on the molding 1.

As mentioned above, the recess may generally have any orientation. For example, in case of an essentially vertical orientation of the recess, a secure fastening of a roof load carrier device can be achieved by a form fitting connection between a recess with inner thread and a securing means in the form of a threaded bolt matching the inner thread, or by a recess which is suitable for a ball lock pin and a ball lock pin suitable for the recess.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A molding for a support structure on a vehicle, said molding having at least one recess for receiving a securing means of a roof load carrier device, and comprising at least one sensor device arranged in the molding, said at least one sensor being configured for detecting a change of a magnetic field in a region of the recess and/or an engagement of the securing means in the recess, wherein the molding is shaped in longitudinal direction for fastening on a motor vehicle without a clearance between a bottom side or a lower free end of the molding and an outer surface of a roof, and has a cross sectional shape so as to enable a fastening of the roof load carrier device to the molding only by engagement of the at least one securing means in the at least one recess of the molding.

2. The molding of claim 1, wherein when the molding is fastened on the motor vehicle, angles at an imaginary intersection between sides of the molding and the roof surface are greater than 90° and smaller than 150°, and a cross sectional width of the molding continuously decreases with an increasing distance to the roof surface.

3. The molding of clam 1, wherein the molding has a portion protruding from the roof of the motor vehicle when the molding is fastened to the roof of the motor vehicle, said portion having essentially along an entire length thereof excluding the at least one recess, a cross sectional shape selected from the group consisting of an essentially circular-section shape with a center angle of smaller than 180°, an ellipse-segment shape, wherein a length of the ellipse-segment is smaller than 50% of a circumference of the ellipse, a two-sided shape, and a three-sided shape having inner angles greater than 90°.

4. The molding of clam 1, wherein corners of the two-sided shape and the three-sided shape are rounded.

5. The molding of claim 1, wherein the at least one recess has a shape selected from the group consisting of an essentially round shape, an essentially angled shape, an essentially oblong-hole shape, a shape with an internal thread and a shape configured for engagement with a ball lock pin.

6. The molding of claim 1, wherein the sensor device includes a mechanical or contactless operating sensor.

7. The molding of claim 6, wherein the sensor device includes at least one member selected from the group consisting of a switching device, a magnetic sensor device, and a sensor device constructed as optical light barrier.

8. The molding of claim 6, wherein the sensor device includes a Reed-contact or a Hall-sensor device.

9. The molding of claim 1, constructed essentially as a hollow section or a solid section.

10. The molding of claim 1, wherein the molding is essentially made of at least one member selected from the group consisting of a metal, a metal alloy, and a plastic material.

11. A roof carrier arrangement for fastening a roof load carrier device on a roof of a vehicle, said roof carrier arrangement comprising two moldings mounted on the roof in transversely spaced apart and essentially parallel relationship to one another, wherein at least one of the two moldings is constructed as the molding of claim 1.

12. A method for controlling a driver assist or driver stabilizing program of a vehicle comprising the steps of:
providing a vehicle including the roof carrier arrangement of claim 10;
detecting a signal of the sensor device arranged in at least one of the moldings
transmitting the signal to a control device of the driver assist system or driver stabilizing system; and
controlling the driver assist system or driver stabilizing system with the control device as a function of a detected change in a magnetic field in a region of the at least one recess of the molding and/or a detected presence or absence of a roof load carrier device.

13. The method of claim 11, wherein the signal is detected when turning on the ignition, when starting the drive device of the vehicle and/or after a standstill of the wheels.

14. The method of claims 11, wherein the driver assist system and/or driver stabilizing program are controlled in response to detecting a roof load carrier device by the control device so as to achieve a maximal driving safety at maximal driving dynamic.
